(19) United States
(12) Patent Application Publication
(10) Pub. No.: US 2002/0125718 A1
(43) Pub. Date: Sep. 12, 2002

(54) Elbow fitting

(76) Inventor: Frank E. Romero, Noti, OR (US)

Correspondence Address: Robert E. Howard, P.O. Box 10345, Eugene, OR, 97440, US

(21) Appl. No.: 09/803,004

(22) Filed: Mar. 8, 2001

(51) Int. Cl. F16L 43/00

(52) U.S. Cl. 285/179

(57) ABSTRACT

An elbow fitting having a threaded connection arm extending from a main body portion along an extension of the longitudinal axis thereof, and a tubing arm extending at right angles to the longitudinal axis of the main body portion. The elbow fitting includes a drive member which allows the connection arm of the elbow to be rotatably threaded into a mating device with a driving tool, such as a wrench, without interference from the tubing arm during rotation of the elbow. The drive member is a prism having a polygonal cross-sectional, the flat surfaces of the prism providing gripping surfaces for the driving tool. The prismatic drive member extends outwardly from the closed end of the elbow, the axis of the prismatic drive member being located along an extension of the axis of the main body portion.

### BACKGROUND OF THE INVENTION

This invention relates to an elbow fitting for use in an area having minimal clearance. More particularly, the invention relates to an elbow fitting for use with an electric dishwasher.

When installing a dishwasher to a water supply line the standard elbow used for the connection is first connected via a first arm to the solenoid valve in the dishwasher that turns the water on and off, and then the elbow is connected to the water line via the second arm. In connecting the elbow to the solenoid valve the male threads on the first arm of the elbow must be screwed into the female threads of the solenoid valve. In the crowded area where the solenoid valve is located, it is difficult to rotate the elbow to screw the first arm into the solenoid valve because the second arm, used for connecting the elbow to the water line, gets in the way.

### SUMMARY OF THE PRESENT INVENTION

It is an object of the present invention to provide an elbow fitting that can more easily be rotated for screwing into place in locations having minimal clearances.

It is a further object of the present invention to provide an elbow fitting for use in connecting electric dishwashers to a water supply line.

These and other objects are achieved by placing a drive member on the elbow in a location adapted to allow the elbow to be easily rotated with a simple driving tool such as a wrench, socket wrench, pliers, or ratchet, to thereby screw the first arm into an arm receiving device.

### BRIEF DESCRIPTION OF THE DRAWINGS

FIG. 1 is a perspective view of the prior art elbow fitting commonly in use for connecting electric dishwashers to a water supply line;

FIG. 2 is a cross-sectional view of the prior art elbow fitting shown in FIG. 1;

FIG. 3 is a perspective view of a first embodiment of the elbow fitting of the present invention; and

FIG. 4 is a perspective view of a second embodiment of the elbow fitting of the present invention.

### DESCRIPTION OF PREFERRED EMBODIMENTS

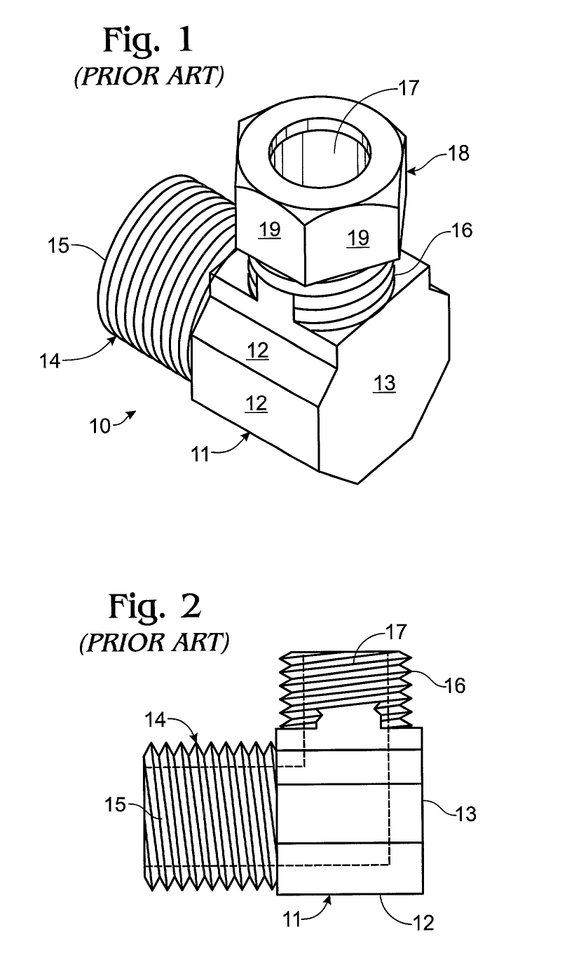

FIG. 1 shows a prior art elbow fitting 10 used for connecting electric dishwashers to water supply tubing. Elbow fitting 10 has a main body 11 having a generally octagonal cross-section with seven external gripping surfaces (wrench flats) 12 and a closed end wall 13.

A threaded connection arm 14, having a longitudinal axis located along an extension of the longitudinal axis of main body 12, extends outwardly from main body 12.

A threaded tubing arm 16, having a longitudinal axis that is perpendicular to the longitudinal axis of main body 12, extends outwardly from main body 12 as shown. A tubing nut 18 is threadably attached to tubing arm 16, tubing nut 18 having six external gripping surfaces 19.

Main body 11, connection arm 14 and tubing arm 16 are integral with each other, and all have central bores that communicate with each other so that water flowing into the bore 17 of tubing arm 16 from a water supply line (not shown) passes through the bore in main body 11 and out through the bore in connection arm 14. The bores in main body 11 and connection arm 14 form a single bore 15, as seen in FIG. 2.

The difficulty with prior art elbow 10 is that when installing the elbow on a dishwasher by first screwing attachment arm 14 into the solenoid valve of the dishwasher using a driving tool that grips wrench flats 12, tubing arm 16 gets in the way of the driving tool used to install the elbow every time the tubing arm 16 rotates into the position facing the installer. The threads on tubing arm 16 can become damaged by the driving tool as the installer tries to continue to rotate the elbow by gripping tubing arm 16 with the driving tool, the tubing nut 18 typically being removed during such installation.

A first embodiment of the elbow of the present invention is illustrated in FIG. 3, where parts common to the prior art elbow illustrated in FIGS. 1 and 2 have the same reference number but increased by 100.

Thus, elbow 110 has a main body 111 having a generally octagonal cross-section with seven external gripping surfaces (wrench flats) 112 on the outer surface thereof and a closed end wall 113.

A threaded connection arm 114, having a longitudinal axis that is an extension of the longitudinal axis of main body 111, extends outwardly from main body 111.

A threaded tubing arm 116, having a longitudinal axis that is perpendicular to the longitudinal axis of main body 111, extends outwardly from main body 111 as shown. A tubing nut 118 is threadably attached to tubing arm 116, tubing nut 118 having six external gripping surfaces 119.

Main body 111, connection arm 114 and tubing arm 116 are integral with each other, and all have central bores that communicate with each other so that water flowing into the bore 117 of tubing arm 116 from a water supply line (not shown) passes through the bore 115 in main body 111 and connection arm 114.

The crux of the invention resides in providing a drive member 120 extending outwardly from closed end wall 113, the longitudinal axis of drive member 120 being located on an extension of the common longitudinal axis of main body 111 and connection arm 114. Drive member 120 is a prism having a polygonal cross-section and having a plurality of gripping surfaces 122 for engaging the driving surfaces of a driving tool, e.g., the jaws of a wrench. Drive member 120 is, preferably, hexagonal in cross-section with six gripping surfaces 122, as illustrated in FIG. 3.

The polygonal cross-section of prismatic driving member 120 of the first embodiment illustrated in FIG. 3 preferably has an inscribed circle that has a radius that is substantially the same as the radius of the bore of main body 11.

When installing elbow 110, drive member 120 is accessible to the driving tool throughout all 360 degrees of rotation of the elbow 110, and tubing arm 116 cannot get in the way.

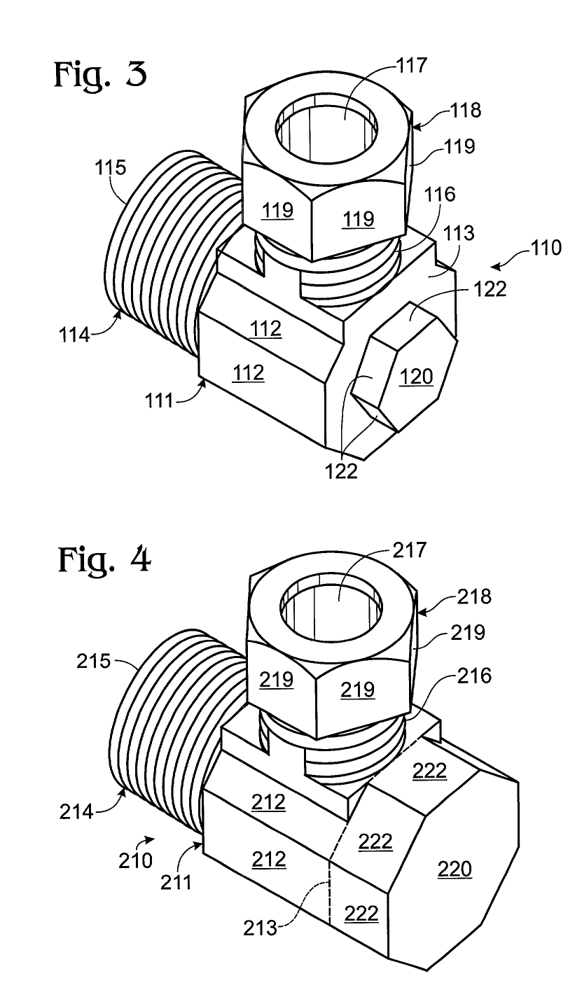

A second embodiment of the elbow of the present invention is illustrated in FIG. 4 where parts common to the prior art elbow of FIGS. 1 and 2 have the same reference number but increased by 200.

Thus, elbow 210 has a main body 211 having a generally octagonal cross-section with seven gripping surfaces (wrench flats) 212 on the outer surface thereof.

In this embodiment, similar to the embodiment of FIG. 3, a prismatic drive member 220 extends outwardly from where end wall 213 (shown in phantom) would normally be located. However, unlike drive member 120 of FIG. 3, the cross-section of prismatic drive member 220 is a polygon (preferably an octagon) having a circumscribed circle whose radius is substantially the same as the “nominal” circumscribed radius of main body 211. By “nominal” circumscribed radius is meant the radius of that circle generated by circumscribing the edges of the wrench flats 212 of main body 211.

Thus, where main body 211 has a generally octagonal cross-section and drive member 220 has an octagonal cross-section, gripping surfaces 222 adjacent wrench flats 212 are substantially coplanar with and extensions of the adjacent wrench flats 212.

A threaded connection arm 214, having a longitudinal axis that is an extension of the longitudinal axis of main body 211, extends outwardly from main body 211.

A threaded tubing arm 216, having a longitudinal axis that is perpendicular to the longitudinal axis of main body 211, extends outwardly from main body 211 as shown.

A tubing nut 218 is threadably attached to tubing arm 216, tubing nut 218 having six external gripping surfaces 219.

Main body 211, connection arm 214 and tubing arm 216 are integral with each other, and all have central bores that communicate with each other so that water flowing into bore 217 of tubing arm 216 from a water supply line (not shown) passes through bore 215 of main body 211 and connection arm 214.

Although drive member 120 has been described as preferably being a prism having a hexagonal cross-section with six gripping surfaces 122, since this provides adequate opportunities for the driving tool to properly engage gripping surfaces 122 of drive member 120, it is possible to use prisms having other polygonal cross-sections. Prismatic drive member 120 could have as few as three gripping surfaces (i.e., have a cross-section that is a triangle) or as many as eight or more. However, using only three gripping surfaces would require a longer stroke with each turn of the driving tool which could cause problems in tight spaces. Although it is also possible to use more than eight gripping surfaces, this would decrease the area available for each of the gripping surfaces which could cause problems with the driving tool properly engaging the gripping surfaces.

Thus, in the embodiment illustrated in FIG. 3 it is preferred to provide between four and eight gripping surfaces, and most preferably either six or eight.

In the embodiment of FIG. 4 it is preferred that the polygonal cross-section of driving member 220 be such that the gripping surfaces 222 are coplanar with and extensions of wrench flats 212. Thus, where main body 211 is generally octagonal in cross-section, it is preferred that the cross-section of driving member 220 be octagonal.

The depth (altitude) of the gripping surfaces 122 or 222, i.e., the distance they extend outwardly from end wall 113 or 213, are such as to provide an adequate area for properly engaging the driving surfaces of a driving tool, e.g., the jaws of a wrench. For most driving tools, gripping surfaces 122 or 222 having a depth of about 5 mm. is adequate.

It is preferred that driving members 120 and 220 be formed integral with main body ill and 211, respectively. However, they could be separately attached, such as by welding.

It will be obvious to those having skill in the art that many changes may be made to the details of the above-described embodiments of this invention without departing from the underlying principles thereof. The scope of the present invention should, therefore, be determined only by the following claims.

The invention claimed is:

1. An elbow fitting comprising:
a main body having an axial main body bore extending from an open front end to a closed rear end;
a cylindrical threaded connection arm extending from the front end of said main body, said connection arm having an axial connection arm bore that is an extension of said main body bore, said main body and said connection arm having a common longitudinal axis;
a cylindrical tubing arm extending from said main body, said tubing arm having an axial tubing arm bore that communicates with said main body bore, said tubing arm bore being perpendicular to said main body bore; and
a drive member located at the closed rear end of said main body, said drive member having a plurality of gripping surfaces adapted to engage the driving surfaces of a driving tool throughout all 360 degrees of rotation of said elbow.

2. The elbow of claim 1 wherein said drive member extends outwardly from said closed rear end of said main body.

3. The elbow of claim 2 wherein said drive member has six gripping surfaces.

4. The elbow of claim 2 wherein said drive member has eight gripping surfaces.

5. The elbow of claim 2 wherein said drive member is a prism having a polygonal cross-section, said drive member having a longitudinal axis that is located along an extension of the common longitudinal axis of said main body and said connection arm, said polygonal cross-section having an inscribed radius that is substantially the same as the radius of said main body bore.

6. The elbow of claim 5 wherein said prism is hexagonal in cross-section.

7. The elbow of claim 2 wherein said main body is generally polygonal in cross-section, and said drive member is a prism having a polygonal cross-section, said drive member having a longitudinal axis that is located along an extension of the common longitudinal axis of said main body and said connection arm, said polygonal cross-section of said drive member having a circumscribed radius that is substantially the same as the nominal circumscribed radius of said main body.

8. The elbow of claim 7 wherein said prism is octagonal in cross-section.
